(19) United States
(12) Patent Application Publication
(10) Pub. No.: US 2005/0210301 A1
(43) Pub. Date: Sep. 22, 2005

(54) Digital system clock control

(76) Inventor: Erkki Nokkonen, Tampere (FI)

Correspondence Address: PERMAN & GREEN, 425 POST ROAD, FAIRFIELD, CT, 06824, US

(21) Appl. No.: 11/059,741

(22) Filed: Feb. 17, 2005

(30) Foreign Application Priority Data
Mar. 18, 2004 (FI) 20040418

(51) Int. Cl. G06F 1/30

(52) U.S. Cl. 713/300

(57) ABSTRACT

A digital system, a method implemented by the system and a mobile device, in which the system can be applied, the system including a system oscillator for providing a system main clock signal, a control block for controlling at least the power management of the digital system and one or more functional blocks, whereof at least one is arranged to detect a need for a system clock. At least one functional block is arranged to send at least one system clock request signal to the control block, which in turn is arranged to enable the system oscillator to provide the system clock signal in response to receiving the system clock request signal. When the system clock signal appears, the at least one functional block is arranged to detect the system clock signal.

### FIELD OF THE INVENTION

The invention relates to digital systems, and especially to a digital system clock control.

### BACKGROUND OF THE INVENTION

All the main system clocking inside a mobile device is typically based on a single oscillator. The same system clock signal is used by many blocks, such as RF (Radio Frequency) transmitter/receiver, modem processor, cellular processor, application processor, Bluetooth, WLAN (Wireless Local Area Network) and GPS (Global Positioning System) blocks, inside the mobile device. The blocks usually consume a significant amount of power whenever the block is active. Switching off the system oscillator enables to save power. Thus the system oscillator is typically switched off when none of the blocks need the common system clock signal. The system is then said to be in a sleep state. The system oscillator is enabled when one or more of the blocks need clocking. The system is then said to be in a wake-up state. Additionally, another oscillator, a low-frequency oscillator, can be used in case of the system is hold for a period in low-activity mode. The low-frequency oscillator typically operates all the time.

However, there is a problem in current digital architectures of mobile devices, for example, that the system typically comprises only one system oscillator, whose enabling can typically only be carried out by a specialized processor block, such as a cellular processor block, which is arranged to send a system clock request to a block controlling the system oscillator, such as a power management unit. When one or more functional blocks, such as WLAN, Bluetooth, GPS or some other block capable to communicate outwards, of the system needs to wake up, the processor block has to be woken up even when the processor block itself does not need the system clock. The more functional blocks the system comprises and the more often the functional blocks need to wake up, the more often the processor block has to wake up and the more power is consumed. For example, the Bluetooth block needs to wake up and at about 1-second intervals to detect the traffic of the RF (Radio Frequency) channels, and the processor block has to be woken up also to enable the system oscillator. In most cases the Bluetooth block does not even have any data to send to the processor block, and therefore, the wake-up of the processor block can be considered as a redundant operation and thus, power is only wasted, which shortens the battery life of the mobile device.

Solutions known from current digital architectures make it possible, for example, for the Bluetooth block to interrupt the processor block, which in turn will enable the power supply regulator in the power management unit for the system oscillator. The processor block has to check what the interrupt is all about. In many cases, nothing else need to be done except wait for the Bluetooth block to complete its operation. After that the processor block disables the system oscillator.

### BRIEF DESCRIPTION OF THE INVENTION

In this invention a method is developed, by which method the drawbacks of the above-mentioned problems can be reduced. A method, a system and a device are described as various aspects of the invention, and they are characterized by what is stated in the independent claims. Preferred embodiments of the invention are set forth in the dependent claims.

The invention is based on the fact that a digital system comprises a main processor unit, a system oscillator for providing a system clock signal, a control block for controlling at least the power management of said digital system and one or more functional blocks, whereof at least one is arranged to detect a need for a system clock. Also, two or more functional blocks can be arranged to request for the system clock at the same time. At least one functional block is arranged to send at least one system clock request signal to the control block, which in turn is arranged to enable the system oscillator to provide the system clock signal in response to receiving the system clock request signal. When the system clock signal appears, said at least one functional block is arranged to detect the system clock signal.

Broadly characterized, the invention may be described to be based on the idea of moving the clock control away from a processor block within said digital system.

The system comprises of at least one common, shared signal, which is used for requesting for the clock.

According to an embodiment of the invention the functional block comprises a clock detection circuitry for detecting the system clock signal or at least one functional block is arranged to receive the system clock signal directly from the control block or in the case of the functional block comprising a slicer and a timer directly from the oscillator as an analogous signal.

According to an embodiment of the invention functional blocks are arranged to detect the system clock signal but to ignore it in response to the fact that the functional block has not requested for the system clock.

According to an embodiment of the invention the control block comprises a timer, which is arranged to allow the system clock to settle, or the timer is comprised by at least one functional block.

According to an embodiment of the invention the system, preferably the control block, comprises at least one slicer, which is arranged, to transform the system clock signal into a digital form.

According to an embodiment of the invention the digital system comprises a filter for removing glitches from the system clock request signal.

The arrangement of the invention provides significant advantages especially in mobile devices. One advantage is that significant power savings can be achieved by the proposed arrangement, because the processor block does not need to wake up every time a functional block wakes up. The arrangement enables longer operation times of battery operated devices, such as longer standby time especially when the Bluetooth block is enabled, longer usage time, for example, for a calendar, short message service (SMS) and note editing, and such low activity use case. Another advantage is that the arrangement is relatively easy and cheap to implement and maintain on account of minor investments in devices and technical simplicity of the implementation.

### BRIEF DESCRIPTION OF THE DRAWINGS

The invention will now be described in greater detail by means of the preferred embodiments and with reference to the attached drawings, in which,

FIG. 1 shows a mobile device, in which the invention can be applied;

FIG. 2 shows a block diagram of a digital system of a preferred embodiment of the invention; and

FIG. 3 shows a flow chart of a method of a preferred embodiment of the invention.

### DETAILED DESCRIPTION OF THE INVENTION

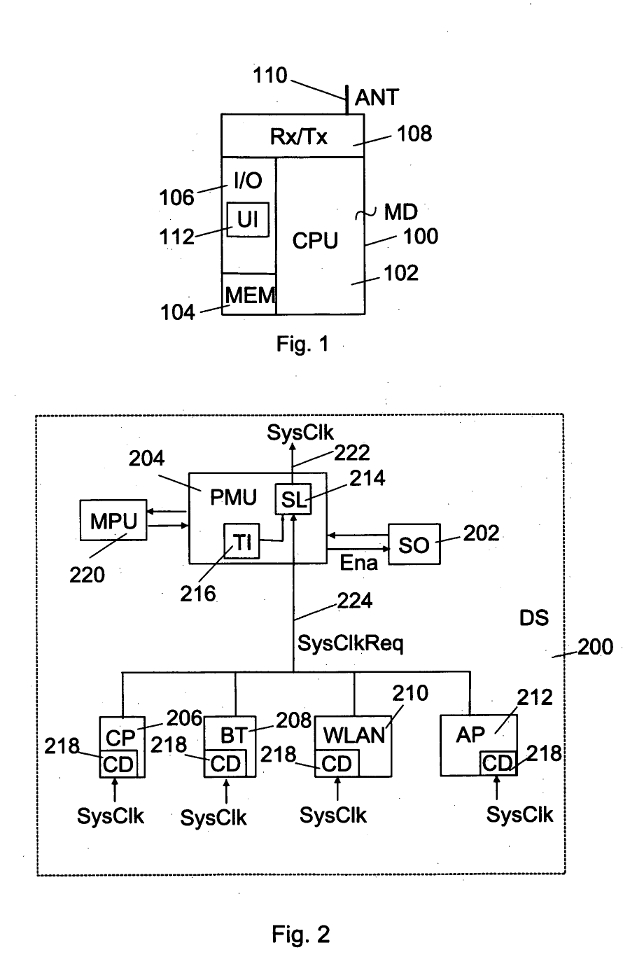

FIG. 1 describes some basic features of a mobile device MD (100), such as a mobile phone, a laptop or a PDA device (Personal Digital Assistant device) in which the invention can be applied. Here the mobile device MD generally refers to a wireless terminal capable of processing data in digital form. The mobile device MD comprises a central processing unit CPU (102) comprising one or more processors, a memory MEM (104), an input/output system I/O (106) and a receiver-transmitter Rx/Tx (108), which is arranged to receive and transmit data according to various data transfer protocols via an antenna ANT (110). The requested data needed is stored in the memory MEM, which typically comprises read memory, such as ROM (Read Only Memory) for storing applications used for controlling the central processor unit CPU and other data to be stored, and write memory, such as RAM (Random Access Memory) and/or FLASH memory for processing temporary data. The mobile device MD communicates outwards, for example with other mobile devices, a network and a user, via the input/output system I/O. A user interface UI (112), which is part of the input/output system I/O, may comprise, for example, an interface, such as a display, keyboard, loudspeaker and microphone, through which the mobile device MD and its user can communicate with each other. Data from the various components can be transmitted to the central processor unit CPU, which further processes the data.

A digital system refers herein to a data processing system that, after having manufactured, essentially comprises the required parts, but to which parts can be added even after manufacturing in such a manner that a new digital system is formed after the addition of the parts.

The functional blocks comprised by the digital system may be for example ASICs, which are logic circuits that may generally have as many as several millions of logic ports formed by transistors, is an example of such a digital system. A clock signal, which synchronizes the operation of the logics on the circuit, is typically generated within the ASIC. Independent logical entities, functional blocks, can be designed into the ASICs. Ready-made blocks that can be integrated in to the circuit, i.e. IPs (Intellectual Property blocks), such as DSP (Digital Signal Processing) cores, processors, memory circuits and counters, are currently available for the ASICs. An ASIC may comprise several or even all the blocks of a digital system.

With reference to the simplified block diagram shown in FIG. 2, the following describes a digital system DS (200) according to a preferred embodiment of the invention, in which the digital system DS of a mobile device comprises a main processor unit MPU (220), a system oscillator SO (202) for providing a system clock signal (222), a control block, which in this case is a power management unit PMU (204), for controlling at least the power management of the digital system DS, and one or more functional blocks, which are typically arranged to carry out operations needed by the system or device. In this case a cellular processor CP (206), a Bluetooth block BT (208), a WLAN block (210) and an application processor AP (212) are functional blocks. The power management unit PMU and the functional blocks CP, BT, WLAN, AP are functionally connected to the system oscillator SO and the blocks CP, BT, WLAN, AP are functionally connected also to the power management unit PMU.

At least one functional block CP, BT, WLAN, AP is arranged to detect a need for a system clock. Typically this is arranged so that the block comprises a timer, which can be used to wake up the functional block for performing tasks. The expiration of the timer causes the need to have the system clock signal available for the functional block. When the functional block CP, BT, WLAN, AP has to wake up, it is arranged to send a system clock request signal to the power management unit PMU. Also two or more functional blocks can request for the system clock at the same time, for example with one or more common signals by means of an open-drain or open-collector signal. Alternatively the system clock request may be used as an input to the block, which means that when one of the blocks activates the system clock, all the other blocks can utilize the information for synchronization for example. For example, if the Bluetooth block BT has to wake up to listen to the RF channels, it is preferably arranged to activate the system clock request signal SysClkReq (224). Preferably, the power management unit PMU comprises a filter for removing glitches at least from the system clock request signal. In consequence of receiving the system clock request signal, the power management unit PMU is arranged to enable the system oscillator SO with an enable signal ENA, which can be a logical signal or regulated voltage, for example. The modification of the system clock signal can be done, for example, in the power management unit PMU, in the functional blocks or partly in power management unit PMU and partly in the functional blocks. In this case the power management block PMU comprises a slicer SL (214), which is arranged to transform the system clock signal from an analogical form to digital form and preferably also to cut up the signal when needed. The system clock signal SysClk appears for all the blocks CP, BT, WLAN, AP as soon as the timer TI (216), preferably comprised by the power management block PMU, expires preferably in such time that the system oscillator SO has enough time to wake up and stabilize. At least one functional block CP, BT, WLAN, AP is arranged to detect the system clock signal for example by a clock detection circuitry CD (218) comprised by the functional blocks CP, BT, WLAN, AP. The clock detection circuitry CD is arranged to detect the system clock signal, and thus, to inform the block CP, BT, WLAN, AP when the clock can be used.

According to a preferred embodiment of the invention the system clock signal is delivered as an analogous signal to the blocks and each block may comprise a timer TI and a slicer SL.

The invention is advantageous especially in cases that the mobile device comprises Bluetooth and WLAN functionality and there is WLAN available in the surrounding. Thus, the mobile device tries to establish a Bluetooth connection to other devices and a WLAN connection is set up all the time, which causes the battery to run out sooner with the traditional approach. Additionally, the digital system of the invention is quite simple and cheap to implement and maintain, for example in mobile phones.

According to a preferred embodiment each functional block comprises a timer, preferably a similar timer, to allow the system clock to settle. In this case the clock slicer is not needed, because the blocks are arranged to carry out the timing and clock signal modification themselves.

According to a preferred embodiment of the invention all the functional blocks CP, BT, WLAN, AP are arranged to receive the system clock signal, but they are arranged to ignore it if they have not requested it. Hence, the blocks do not have to wake up without their operation is needed, which enables power savings to be made in the system.

According to a preferred embodiment of the invention the power management unit PMU is arranged to send a clock acknowledgement signal to the functional blocks CP, BT, WLAN, AP for indicating that the system clock is up and running. Thus, the functional blocks CP, BT, WLAN, AP are arranged to receive the system clock signal directly from the power management unit PMU and the clock detection circuitries CD are therefore not necessarily needed.

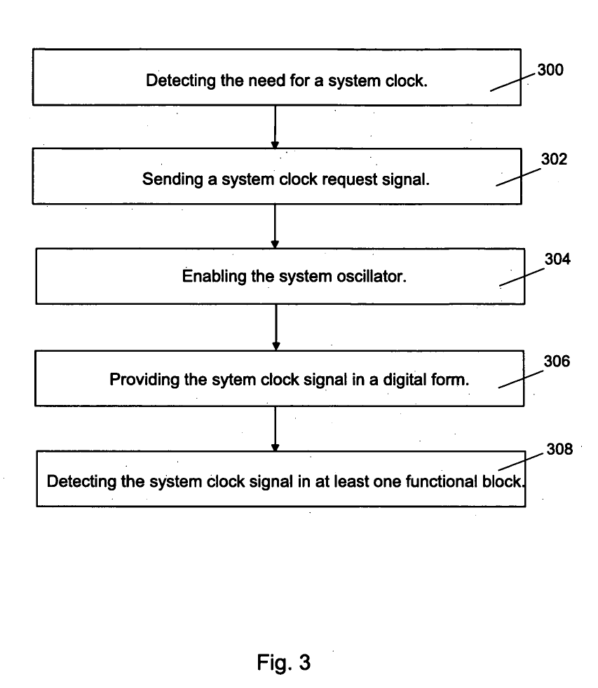

A method for controlling a digital system clock can be applied to the digital system. FIG. 3 shows a flow chart of a method of a preferred embodiment of the present invention. A need for a clock signal arises, for example, when a Bluetooth connection is set up, and thus, the need for a clock is detected in at least one functional block 300. A system clock request signal is sent from the functional block 302 in order to enable the system oscillator 304 to provide the system clock signal in response to receiving the system clock request signal 306. The system clock signal is then detected in at least one functional block 308.

It is obvious to a person skilled in the art that while the technology advances, the basic idea of the invention can be implemented in many different ways. The invention and its embodiments are thus not restricted to the examples described above, but can vary within the scope of the claims.

1. A digital system comprising at least:
a main processor unit;
a system oscillator for providing a system clock;
one or more functional blocks, whereof at least one is configured to detect a need for a system clock; and
a power management control block separate from the main processor unit and configured to control the system oscillator in order to provide the system clock in response to receiving a system clock request from at least one said functional blocks, said functional block being capable of waking up by itself and configured to send at least one system clock request signal to the control block to request the system clock.

2. A digital system as claimed in claim 1, wherein:
said at least one functional block is configured to detect the system clock signal.

3. A digital system as claimed in claim 1, wherein:
said at least one functional block comprises a clock detection circuitry, which is configured to detect the system clock signal.

4. A digital system as claimed in claim 1, wherein:
said at least one functional block is configured to receive the system clock signal directly from the control block.

5. A digital system as claimed in claim 1, wherein:
said at least one functional block is configured to ignore the system clock signal in response to the fact that the functional block has not requested for the system clock.

6. A digital system as claimed in claim 1, wherein:
two or more functional blocks are configured to request for the system clock at the same time.

7. A digital system as claimed in claim 1, wherein:
the control block comprises a slicer, which is configured to transform the system clock in digital form.

8. A digital system as claimed in claim 1, wherein:
the control block comprises a timer, which is configured to allow the system clock to settle.

9. A digital system as claimed in claim 1, wherein:
at least one functional block comprises a timer, which is configured to allow the system clock to settle.

10. A digital system as claimed in claim 1, wherein the digital system further comprises:
a filter for removing glitches from the system clock request signal.

11. A method in a digital system said system comprising at least:
a main processor unit;
a system oscillator for providing a system clock;
one or more functional blocks, whereof at least one is configured to detect a need for a system clock; and
a power management control block separate from the main processor unit and the method comprising:
controlling the system oscillator in order to provide the system clock in response to receiving a system clock request from at least one said functional blocks, said functional block being capable of waking up by itself and configured to send at least one system clock request signal to the control block to request the system clock.

12. A method as claimed in claim 11, further comprising:
detecting the system clock signal in said at least one functional block.

13. A method as claimed in claim 11, further comprising:
detecting the system clock signal by a clock detection circuitry.

14. A method as claimed in claim 11, further comprising:
receiving the system clock signal directly from the control block.

15. A method as claimed in claim 11, further comprising:
ignoring the system clock signal in response to the fact that the functional block has not requested for the system clock.

16. A method as claimed in claim 11, further comprising:
transforming the system clock in digital form by means of a slicer comprised by the control block.

17. A method as claimed in claim 11, further comprising:
allowing the system clock to settle by a timer.

18. A method as claimed in claim 11, further comprising:
removing glitches from the system clock request signal.

19. A mobile device comprising a digital system having at least:
a main processor unit;
a system oscillator for providing a system clock;
one or more functional blocks, whereof at least one is configured to detect a need for a system clock; and
a power management control block separate from the main processor unit and configured to control the system oscillator in order to provide the system clock in response to receiving a system clock request from at least one said functional blocks, said functional block being capable of waking up by itself and configured to send at least one system clock request signal to the control block to request the system clock.

20. A mobile device as claimed in claim 19, wherein the mobile device further comprises:
means for detecting the system clock signal in said at least one functional block.

21. A mobile device as claimed in claim 19, wherein the mobile device further comprises:
means for receiving the system clock signal directly from the control block;

22. A mobile device as claimed in claim 19, wherein the mobile device further comprises:
means for ignoring the system clock signal in response to the fact that the functional block has not requested for the system clock.

23. A mobile device as claimed in claim 19, wherein the mobile device further comprises:
means for transforming the system clock in digital form.

24. A mobile device as claimed in claim 19, wherein the mobile device further comprises:
means for allowing the system clock to settle.

25. A mobile device as claimed in claim 19, wherein the mobile device further comprises:
means for removing glitches from the system clock request signal.

26. A mobile device as claimed in claim 19, wherein the mobile device is one of the following or a combination thereof:
a mobile communication device
a mobile data processing device.
